(19) United States
(12) Patent Application Publication
(10) Pub. No.: US 2008/0154958 A1
(43) Pub. Date: Jun. 26, 2008

(54) Expanding media content item information

(75) Inventors: David H. Sloo, Menlo Park, CA (US); Peter J. Potrebic, Calistoga, CA (US); Shannon Vosseller, San Francisco, CA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/642,406

(22) Filed: Dec. 20, 2006

(51) Int. Cl. G06F 17/00; G06F 17/30

(52) U.S. Cl. 707/104.1; 707/E17.004

(57) ABSTRACT

In a method for expanding upon media content information presented in a listing of a media content item in an electronic program guide, metadata of a listing of a media content item in an electronic program guide is analyzed to identify trigger information associated with the media content item. The trigger information is provided to an individualized media content information gathering engine. The individualized media content information gathering engine is utilized to perform a specialized data collection process based upon the trigger information. The specialized data collection process is for gathering expanded media content information regarding the media content item.

### BACKGROUND

Consumers today are confronted with an ever increasing number of television channels and video media content items. This can make viewing decisions and media content item selection decisions difficult for a media consumer. Electronic program guides are one way to organize and present media content items which are available via broadcast, subscription, download, or the like. Presently, however, electronic program guides contain only a limited amount of media content information (metadata) regarding the media content items which are listed in the electronic program guides.

Consider, for example, a media content item which is a Monday Night Football broadcast. A typical electronic program (EPG) guide may carry the name of the media content item “Monday Night Football”, the station on which it airs, the network on which it airs, the time period in which it airs, and a short description about the game (such as the teams and their current win/loss records). Additionally, metadata in the form of a series identifier, which is typically not displayed, exists to facilitate the easy identification of episodes of Monday Night Football in the case of a user selecting a series record option (to record recurring episodes of Monday Night Football). Typically, only a few recording options are offered by EPG listings of a media content item. Examples of these few recording options typically fit in the categories of: record this episode; create a series recording (such as every episode of Monday Night Football); or set a reminder.

The metadata about a media content item in an EPG is limited, but is typically enough to identify the media content item to a consumer. However, there are numerous other factors which may weigh in upon a decision to select and watch (or record) an item of media content. Because of this, the lack of additional information, beyond mere basic identification of the media content item, can be frustrating to a consumer.

Likewise, a consumer's interest in the media content item may be of such a nature that the typically presented recording options of merely recording a single episode of the media item, setting a reminder, or else creating a series recording of recurring episodes of the media item, do not satisfy the consumer's need. As such, a user may be forced to perform a complicated query, set up a specialized recording option, or manually find and record related shows of interest, because the two recording options typically available are so limited. This can be frustrating, especially if it requires complicated use of a limited input device such as a mobile phone or remote control to create an on screen query or to step through numerous menus and selections.

Thus, a technology which addresses some of the above disadvantages and limitations with the media content information presented in electronic program guides would be advantageous.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A technology for expanding media content item information is disclosed. The technology provides a method and a system for expanding upon media content information presented in a listing of a media content item in an electronic program guide. The method analyzes metadata of a listing of a media content item in an electronic program guide to identify trigger information associated with the media content item. The trigger information is provided to an individualized media content information gathering engine. The individualized media content information gathering engine is utilized to perform a specialized data collection process based upon the trigger information. The specialized data collection process is for gathering expanded media content information regarding the media content item. This expanded media content information may be presented, for example, to assist a consumer with a selection decision as to whether the consumer is interested in watching or recording a media content item, such as, for example, a television show.

The technology also provides a method for displaying an expanded series recording option for a listing of a media content item in an electronic program guide. A specialized data collection process is performed to generate a series grouping of which the media content item is a member. The specialized data collection process is based upon metadata of the listing. The method presents the series grouping upon a display device, such as a television, as an expanded series recording option in an enhanced electronic programming guide listing associated with the media content item. In response to a user selection of the expanded series recording option, the method marks items of the series grouping for recording.

### DESCRIPTION OF THE FIGURES

The accompanying figures, which are incorporated in and form a part of this specification, illustrate embodiments of the technology for expanding media content item information and, together with the description, serve to explain principles discussed below:

FIG. 1 is a diagram of an example computer system used in accordance with various embodiments of the present technology.

FIG. 2 is a block diagram of an example system for expanding media content item information, in accordance with an embodiment of the present technology.

FIG. 3 is a flow diagram of operations performed in accordance with an embodiment of the present technology.

FIG. 4 shows an example of expanding media content item information for a sports media item, in accordance with an embodiment of the present technology.

FIG. 5 shows an example of expanding media content item information for a movie media item, in accordance with an embodiment of the present technology.

FIG. 6 shows an example of expanding media content item information for a news media item, in accordance with an embodiment of the present technology.

FIG. 7 shows an example of expanding media content item information for a children's show media item, in accordance with an embodiment of the present technology.

FIG. 8 shows an example of expanding media content item information for a prime time television media item, in accordance with an embodiment of the present technology.

FIG. 9 is another flow diagram of operations performed in accordance with an embodiment of the present technology.

The figures referred to in this description should be understood as not being drawn to scale unless specifically noted.

### DETAILED DESCRIPTION

Reference will now be made in detail to embodiments of the present technology for expanding media content item information, examples of which are illustrated in the accompanying drawings. While the technology for expanding media content item information will be described in conjunction with various embodiments, it will be understood that they are not intended to limit the present technology for expanding media content item information to these embodiments. On the contrary, the presented technology for expanding media content item information is intended to cover alternatives, modifications and equivalents, which may be included within the spirit and scope the various embodiments as defined by the appended claims. Furthermore, in the following detailed description, numerous specific details are set forth in order to provide a thorough understanding of the present technology for expanding media content item information. However, the present technology for expanding media content item information may be practiced without these specific details. In other instances, well known methods, procedures, components, and circuits have not been described in detail as not to unnecessarily obscure aspects of the present embodiments.

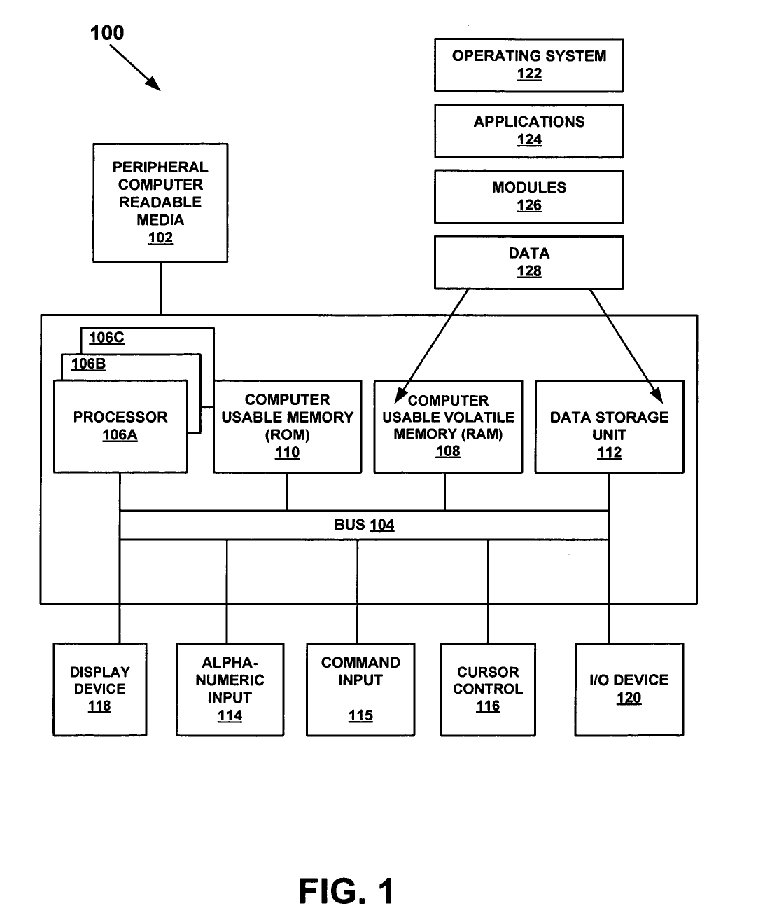

Unless specifically stated otherwise as apparent from the following discussions, it is appreciated that throughout the present detailed description, discussions utilizing terms such as “analyzing”, “providing”, “utilizing”, “presenting”, “gathering”, “generating”, “performing”, “marking”, “identifying”, and “comparing”, or the like, refer to the actions and processes of a computer system (such as computer 100 of FIG. 1), or similar electronic computing device such as a digital video recorder, television decoder box, or television tuner. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for expanding media content item information is also well suited to the use of other computer systems such as, for example, optical and virtual computers. Additionally, it should be understood that in embodiments of the present technology for expanding media content item information, one or more of the steps can be performed manually.

### Example Computer System Environment

With reference now to FIG. 1, portions of the technology for expanding media content item information are composed of computer-readable and computer-executable instructions that reside, for example, in computer-usable media of a computer system. That is, FIG. 1 illustrates one example of a type of computer that can be used to implement embodiments, which are discussed below, of the present technology for expanding media content item information. FIG. 1 illustrates an example computer system 100 used in accordance with embodiments of the present technology for expanding media content item information. It is appreciated that system 100 of FIG. 1 is only an example and that the present technology for expanding media content item information can operate on or within a number of different computer systems including general purpose networked computer systems, embedded computer systems, routers, switches, server devices, client devices, various intermediate devices/nodes, stand alone computer systems, personal media devices, media players, digital video recorders, television decoders, television tuners, and a variety of media devices utilizing electronic program guides.

As shown in FIG. 1, computer system 100 of FIG. 1 is well adapted to having an optional peripheral computer readable media 102 such as, for example, a floppy disk, a compact disc, and the like coupled thereto. System 100 of FIG. 1 includes an address/data bus 104 for communicating information, and a processor 106A coupled to bus 104 for processing information and instructions. As depicted in FIG. 1, system 100 is also well suited to a multi-processor environment in which a plurality of processors 106A, 106B, and 106C are present. Conversely, system 100 is also well suited to having a single processor such as, for example, processor 106A. Processors 106A, 106B, and 106C may be any of various types of microprocessors. System 100 also includes data storage features such as a computer usable volatile memory 108, e.g. random access memory (RAM), coupled to bus 104 for storing information and instructions for processors 106A, 106B, and 106C. System 100 also includes computer usable non-volatile memory 110, e.g. read only memory (ROM), coupled to bus 104 for storing static information and instructions for processors 106A, 106B, and 106C. Also present in system 100 is an optional data storage unit 112 (e.g., a magnetic or optical disk and disk drive) coupled to bus 104 for storing information and instructions. System 100 also includes an optional alphanumeric input device 114 including alphanumeric and function keys coupled to bus 104 for communicating information and command selections to processor 106A or processors 106A, 106B, and 106C. System 100 also includes an optional command input device 115 including command input buttons and/or cursor control keys. Command input device 115 may be a wired or wireless command based input device and may be similar or equivalent to a television remote control. System 100 also includes an optional cursor control device 116 coupled to bus 104 for communicating user input information and command selections to processor 106A or processors 106A, 106B, and 106C. System 100 of the present embodiment also includes an optional display device 118 coupled to bus 104 for displaying information.

Referring still to FIG. 1, optional display device 118 of FIG. 1 may be a liquid crystal device, cathode ray tube, plasma display device or other display device suitable for creating graphic images and alphanumeric characters recognizable to a user. Optional cursor control device 116 allows the computer user to dynamically signal the movement of a visible symbol (cursor) on a display screen of display device 118. Many implementations of cursor control device 116 are known in the art including a trackball, mouse, touch pad, joystick or special keys on alphanumeric input device 114 or command input device 115 capable of signaling movement of a given direction or manner of displacement. Alternatively, it will be appreciated that a cursor can be directed and/or activated via input from alphanumeric input device 114 using special keys and/or key sequence commands. System 100 is also well suited to having a cursor directed by other means such as, for example, voice commands. System 100 also includes an optional I/O device 120 for coupling system 100 with external entities. For example, in some embodiments, I/O device 120 is a modem, network interface device, receiver, transmitter, or transceiver for enabling wired or wireless communications between system 100 and an external device or a network such as, but not limited to, the Internet and/or a computer network.

Referring still to FIG. 1, various other optional components are depicted for system 100. Specifically, when present, an operating system 122, applications 124, modules 126, and data 128 are shown as typically residing in one or some combination of computer usable volatile memory 108, e.g. random access memory (RAM), and data storage unit 112. In one embodiment, the present technology for expanding media content item information is stored, for example, as an application 124 or module 126 in memory locations within RAM 108 and memory areas within data storage unit 112.

### Overview

The following discussion will begin with a description of the structure of a media content information expanding system 200. Discussion will proceed to description of an implementation of an example method for expanding upon media content information presenting in a listing of a media content item in an electronic program guide. Operation of components of system 200 will be described in greater detail in conjunction with the examples presented for illustration of this method. Discussion will proceed to a description of components of system 200 used in an example method for displaying, on a display device, an expanded series recording option for a listing of a media content item in an electronic program guide. Example expanded electronic program guide information and displays will be discussed to further illustrate these methods.

### Example Media Content Information Expanding System

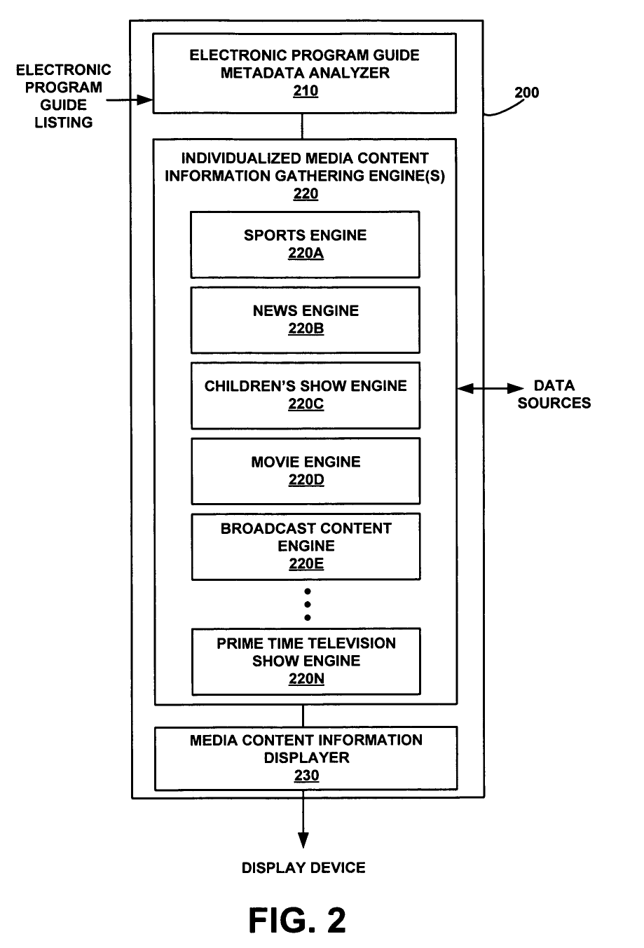

FIG. 2 shows a block diagram of components of an example system 200 for expanding media content information from the limited information presented in an electronic program guide (EPG), according to various embodiments of the present technology. With respect to structure, system 200 is comprised of an EPG metadata analyzer 210, individualized media content information gathering engines 220, and a media content information displayer 230. In one embodiment, system 200 is implemented as a portion of a computer system 100 or other similar electronic device such as a digital video recorder, television tuner, or television decoder.

EPG metadata analyzer 210 analyzes both displayed and undisplayed metadata from an EPG listing for a media content item, such as a television show. As shown in FIG. 2, in one embodiment EPG metadata analyzer 210 is coupled with an EPG for receiving one or more listings. One example of typically undisplayed metadata that is analyzed is the series identifier for the media content item. This is an alphanumeric identifier, bit array, data blob, string, or code that is a unique value associated with a particular media content item, such as a television show. Other examples of typically displayed metadata that may be analyzed are the title of the media content item, the network on which the media content item is carried, the time period (time of day) in which a media content item airs, the duration (length of time) for which a media content item airs, and the description of the media content item which is provided by the EPG. The description may contain a variety of descriptive metadata such as a category (e.g., sports, movie, television show), a genre/sub-category (e.g., drama, comedy, football, basketball), the actors or personalities, and whether the media content item is live, rebroadcast, new, or repeated. In one embodiment, EPG metadata analyzer 210 may analyze metadata from other sources in addition to the EPG listing for a media content item.

EPG metadata analyzer 210 analyzes one or more pieces of such media content item metadata from the EPG listing for the media content item for. The purpose of the analysis is identifying trigger information. Trigger information may be words, terms, categories, and the like, which are associated with the media content item, and which may be used to conduct searches or otherwise gather more information about the media content item. For a media content item that is a sporting event, examples of such trigger information may be the name of a player, the word “football”, the name of a team, the name of a network, the name of a city, and so forth. Additionally, in one embodiment, EPG metadata analyzer 210 analyzes one or more components of the media content item metadata from the listing to initially categorize the type of media content item. For example, is the media content item a prime time television show, a sporting event, a children's television show, a news show, a movie, or some other type of media content item? The native EPG listing often, but not always contains this sort of category information. In one embodiment, the EPG metadata analyzer may additionally analyze broadcast information, such as one or more video frames of a broadcast or closed captioning of a broadcast, to determine a category, such as sports, or a sub-category/genre, such as football, which the media content item may be assigned to.

In one embodiment where the native EPG does not contain category metadata, duration metadata may be analyzed to determine the difference between a movie and a television show (as movies are typically longer than 90 minutes and television shows typically shorter). In one embodiment, time period metadata may be analyzed to determine the difference between a prime time television show and a children's show, which may air at distinct times of day on certain networks. This initial categorization is useful, for example, for determining an individualized media content information gathering engine toward which to direct trigger information.

In one embodiment where the native EPG does contain category metadata, genre metadata may be analyzed to even better determine how to categorize a media content item. For example, if native category information indicates that a media content item is sports programming, further genre metadata analysis may of metadata in the native EPG may allow determination of what type of sports programming, such as a basketball game, a baseball game, a football game, a sports highlights show. By analyzing genre metadata, EPG metadata analyzer 210 can more accurately determine the selection of an individualized media content gathering engine and can provide more specialized trigger information with which to conduct searches.

Individualized media content information gathering engine(s) 220 represents a collection or grouping of one or more individualized media content gathering engines (220A, 220B, 220C, 220D, 220E and 220N for example) which are coupled to EPG metadata analyzer 210. Each individualized media content information gathering engine 220 is configured for performing a specialized data collection process based upon the trigger information supplied to it. The specialized data collection process is for gathering expanded media content information regarding the media content item of the listing which was initially analyzed by EPG metadata analyzer 210. Gathered expanded media content information may then be formatted and displayed, such as in an enhanced EPG, to provide expanded media content item information for the subject listing of a media content item.

FIG. 2 shows several examples of individualized media content information gathering engines 220 in the form of a sports engine 220A focused on gathering information pertinent sports media content items; a news engine 220B focused on gathering information pertinent to sports media content items; a children's show engine 220C focused on gathering information pertinent to children's media content items; a movie engine 220D focused on gathering information pertinent to movie media content items; a broadcast content engine 220E focused on gathering information from an on going broadcast of a media item (such as through analysis of closed captioning data or analysis of one or more frames of broadcast video); and a prime time television show engine 220N focused on gathering information pertinent to prime time television show media content items. Although specific individualized media content information gathering engines 220A, 220B, 220C, 220D, and 220N are shown in FIG. 2, they are presented as examples only. It is appreciated that other implementations may have a greater or lesser number, or different types of individualized media content information gathering engine(s) 220 than those displayed in FIG. 2. For example, one embodiment of system 200 may utilize a reality show engine, a daytime soap-opera engine, and/or a game show engine as one or more of the individualized media content information gathering engines.

An individualized media content information gathering engine 220 is coupled to or capable of accessing or searching one or more data sources for the purpose of gathering individualized media content information based upon supplied trigger information. Some examples of such data sources include, but are not limited to: a second or multiple other electronic program guide listings; a sports information service such as a sports ticker or a team website; a historical listing of sports broadcasts such as an archive which may allow download and viewing of vintage sporting events; a ratings service which provides ratings in for movies or programming on television; a weather service which provides forecast and local conditions for a particular city or region; a movie database which allows searches by actor, director, movie title, or the like, for information about a movie or principals involved in the production of a movie; a news service such as a network or internet website which posts current news items of interest; a syndication feed such as an RSS (Really Simple Syndication) feed, or the like, which receives news items from selected sources; a collaborative filtering service which provides rankings, recommendations, related choices, or the like based upon filtering a plurality of consumer inputs; and a programming review service which critically reviews or critiques movies and/or television shows. Such data sources may be accessible, for example, via the Internet.

Media content information presenter 230 is coupled to individualized media content information gathering engine(s) 220. Media content information presenter 230 is configured for presenting a gathered item of expanded media content information in a displayable user interface. In one embodiment, this comprises formatting gathered information from an individualized media content information gathering engine 220 for display on a display device 118 (FIG. 1), which may be a television or other video display device. This may also comprise formatting gathered information into an enhanced electronic program guide (EEPG) listing, several examples of which are provided herein.

In one embodiment, media content information presenter 230 formats a piece of gathered information for presentation as decision support information. Decision support information is a form of expanded media content item information which further assists a consumer in making a decision as to whether to watch, purchase, or record a media content item. In one embodiment this includes providing selectable “on demand” viewing options that are associated with the media content item displayed in the EPG or providing an option to search for related on demand viewing options. In one embodiment, media content information presenter 230 formats a gathered piece or grouping of information for presentation as one or more series recording options for a consumer to choose from. For example, other recording options may be offered in addition to or in place of typical EPG options to record a media content item or record a series which constitutes other media content items with the same series identifier metadata. In one embodiment for instance, a consumer may be offered one or more additional series groupings of media content items which have been gathered and/or grouped by an individualized media content information gathering engine 220. In one embodiment, such an additional series grouping may be recorded, for example, with one selection of a button, icon, or selectable region on a presented on a display.

### Example Methods of Operation

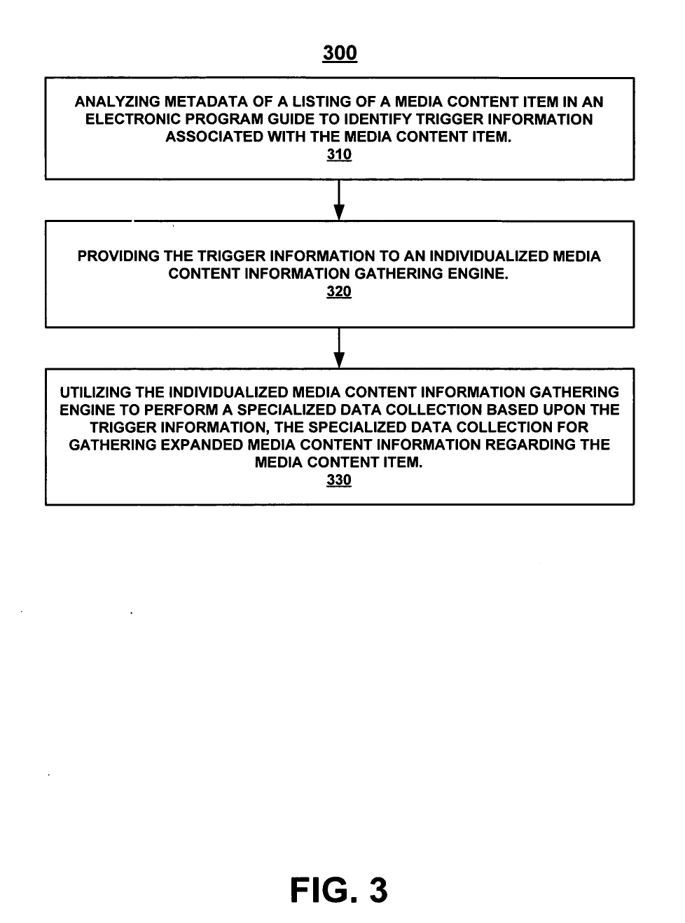

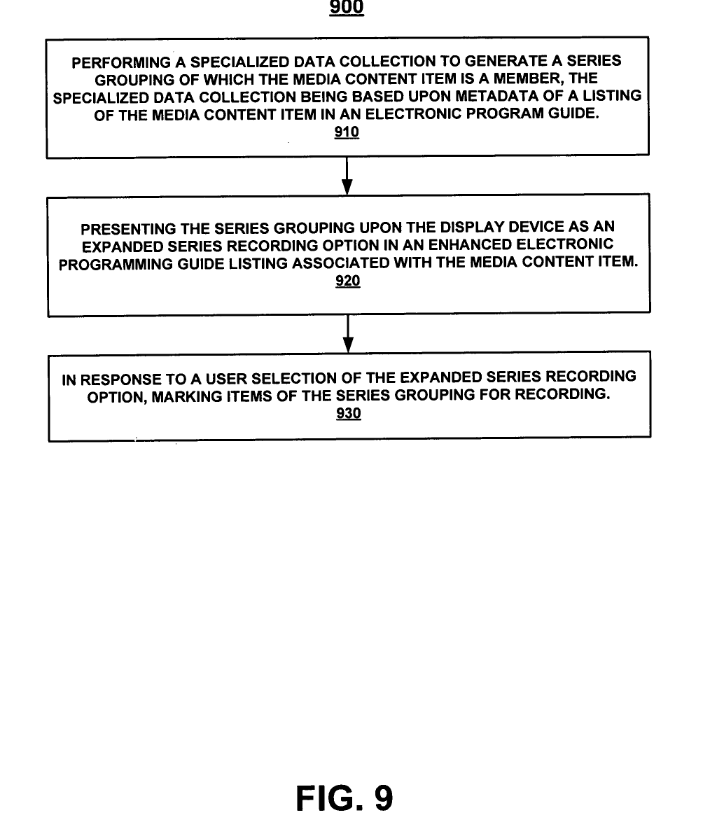

The following discussion sets forth in detail the operation of present technology for expanding media content item information. With reference to FIG. 3 and FIG. 9, flow diagrams 300 and 900 each illustrate example steps used by various embodiments of the present technology for expanding media content item information. Flow diagrams 300 and 900 include processes that, in various embodiments, are carried out by a processor under the control of computer-readable and computer-executable instructions. It is appreciated that in some embodiments, all or parts of methods 300 and 900 may be performed by processors that are at distributed locations linked by a network. For example a portion of method 300 or 900 may be performed in a media center, digital video recorder, television decoder box, or television tuner, while another portion of method 300 or 900 is performed by a server at a remote location. The computer-readable and computer-executable instructions reside, for example, in data storage features such as computer usable volatile memory 108, computer usable non-volatile memory 110, data storage unit 112, and/or peripheral computer-readable media 102 of FIG. 1. The computer-readable and computer-executable instructions are used to control or operate in conjunction with, for example, processor 106A and/or processors 106A, 106B, and 106C of FIG. 1. Although specific steps are disclosed in flow diagrams 300 and 900, such steps are examples. That is, embodiments are well suited to performing various other steps or variations of the steps recited in flow diagrams 300 and 900. It is appreciated that the steps in flow diagrams 300 and 900 may be performed in an order different than presented, and that not all of the steps in flow diagrams 300 and 900 may be performed.

### Expanding Upon Media Content Information Presented in a Listing of a Media Content Item in an Electronic Program Guide

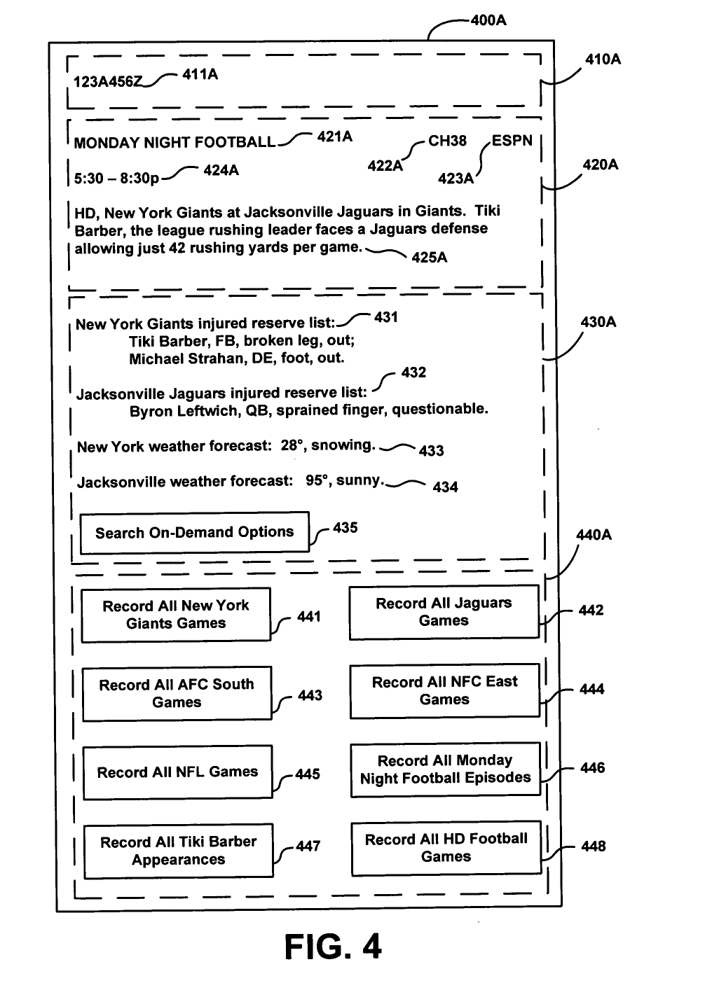

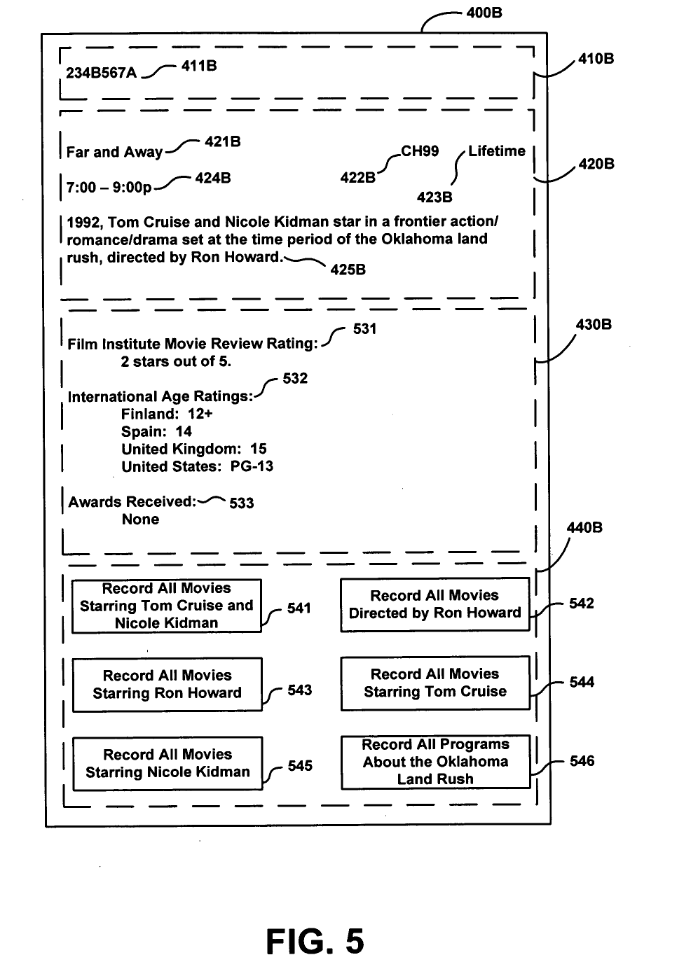

FIG. 3 is a flow diagram 300 of operations performed in accordance with one embodiment of the present technology for expanding media content item information. More specifically, FIG. 3 illustrates a flow diagram 300 of an example embodiment of a method of expanding upon media content information presented in a listing of a media content item in an electronic program guide. Elements of system 200 and the method of flow diagram 300 are explained below, with reference to elements of FIG. 4. FIGS. 5, 6, 7, and 8 provide additional examples of the use of system 200 and/or the method illustrated by flow diagram 300.

At step 310 of flow diagram 300, in one embodiment, the method analyzes metadata of a listing of a media content item in an electronic program guide to identify trigger information associated with the media content item. In one embodiment, for example, EPG metadata analyzer 210 analyzes metadata of a listing of a media content item in an EPG.

With reference now to FIG. 4, an example of expanding media content item information for a sports media item is shown, in accordance with an embodiment of the present technology. FIG. 4 also shows examples of typical displayed metadata 420A and undisplayed metadata 410A from a typical EPG listing for a sports media content item. Thus, a typical EPG listing for a sports media content item would display metadata regarding the media content item such as a title 421A (MONDAY NIGHT FOOTBALL); a channel 422A (CH38); a network 423A (ESPN) which is airing the media content item; a time slot 424A (5:30-8:30 p) in which the media content item is scheduled to air; and a brief description 425A of the media content item. Typically, undisplayed metadata such as a series identifier 411A (123A456Z) is also included with an EPG listing. Thus, in one embodiment the method of 310 comprises analyzing an item of metadata selected from the group of metadata items consisting of: a title of the media content item, a description of the media content item provided in the listing, and a series identifier metadata of the listing.

In one embodiment, EPG metadata analyzer 210 analyzes such displayed metadata 420A and/or undisplayed metadata 410 for trigger information. Some examples of trigger information which EPG metadata analyzer 210 may identify from displayed metadata 420A of FIG. 4 include: “HD” which indicates that this is a high definition broadcast; “FOOTBALL”; “New York”; “New York Giants”; “Tiki Barber”; “Jacksonville”; and “Jacksonville Jaguars”.

At step 320, in one embodiment, the method provides the trigger information to an individualized media content information gathering engine 200. In one embodiment, as shown in FIG. 2, this comprises providing the trigger information to an individualized media content information gathering engine 200 selected from the group of individualized media content information gathering engines 200 consisting of: a sports media content information gathering engine 220A, a news media content information gathering engine 220B, a movie media content information gathering engine 220C, a children's programming media content information gathering engine 220D, and a prime time television show media content gathering engine 220N.

Following the present example illustrated by FIG. 4, in one embodiment, a filter or logic of EPG metadata analyzer 210 determines from the identified trigger information, or other metadata 410A or 420A, that the media content item may be categorized as a sporting event. EPG metadata analyzer 420A then forwards the identified trigger information to sports media content information gathering engine 220A. In one embodiment, this may comprise forwarding the identified trigger information to an individualized media content information gathering engine 220 for a specific sport such as, for example, football, baseball, basketball, soccer, golf, or auto racing.

At step 330, in one embodiment, the method utilizes the individualized media content information gathering engine to perform a specialized data collection process based upon the trigger information. In such an embodiment, the specialized data collection process is for gathering expanded media content information regarding the media content item. In various embodiments, this may comprise utilizing the trigger information as a basis for searching or otherwise gathering information from data sources such as, for example: a second (or subsequent) electronic program guide listing, a sports information service, a historical listing of sports broadcasts, a ratings service, a weather service, a movie database, a news service, a syndication feed, a collaborative filter, and a programming review service, among others.

Following the previous example illustrated by the football game media content item described by metadata 420A and 410A of FIG. 4, in one embodiment, sports media content information gathering engine 220A accesses or searches a sports news service, additional electronic program guide listings, and a weather service utilizing the above described trigger information to gather expanded media content item information. For example, injured reserve list information for each of the teams in the game is gathered from a sports news service. In a similar fashion, current or projected weather information for the home cities of each of the teams is gathered from a weather service.

Additionally, via a specific search of metadata (420) of other EPG listings and other data sources using the triggering information or the series identifier 411A, expanded series groupings related to the media content item (a football game) are gathered. For example in one embodiment a list of series grouping identified by sports media content information gathering engine 220A comprises: a series grouping of all NY Giants games; a series grouping of all Jaguars games; a series grouping of all American Football Conference (AFC) South games; a series grouping of all National Football Conference (NFC) East games; a series grouping of all National Football League (NFL) games; a series grouping of all Monday Night Football games (which may have previously been identified by an existing electronic program guide function); a series grouping of all Tiki Barber appearances; and a series grouping of all High Definition (HD) football games. In each of these series groupings that is generated the media content item (football game) is a member, for example by virtue of the sport, the league, the conference, the type of broadcast, or a player from a team.

In one embodiment, the method of flow diagram 300 further comprises presenting an item of gathered expanded media content information in a displayable user interface along with the listing. In one embodiment, media content information displayer 230 configures one or more items of gathered expanded media content information for display on a display device such as a television or display device 118. In one embodiment, the expanded media content information is displayed as an enhanced electronic program guide (EEPG) listing. EEPG listing 400A of FIG. 4 shows one embodiment of a display of a variety of items of gathered expanded media content information. In EEPG 400A, original undisplayed metadata 410A is included (and may be displayed or hidden) and original displayed metadata 420A is included.

In one embodiment, an item of expanded media content information is presented as an expanded series recording option, wherein the media content item is a member of a grouping of media items encompassed by the expanded series recording option. In EEPG listing 400A, a variety of expanded series groupings are presented as expanded series recording options 440A. Thus the expanded series recording options shown are: “Record all NY Giants games” 441; a “Record all Jaguars games” 442; “Record all American Football Conference (AFC) South games” 443; “record all National Football Conference (NFC) East games” 444; “Record all National Football League (NFL) games” 445; “Record all Monday Night Football games” 446 (which may been identified by an existing electronic program guide function); “Record all Tiki Barber appearances” 447; and “Record all High Definition (HD) football games”. As can be seen each expanded series recording option 440A has a descriptive name which describes the series grouping it represents.

In various embodiments, as shown in FIGS. 4, 5, and 8, expanded series recording options (440A, 440B, 440E) are presented as a selectable menu of series groupings which a user may select from, such as with a cursor input via a remote control or other cursor control device 116, command input 115, alphanumeric input 114, or some other selection means. As these series groupings are pre-built, this allows a user to easily select a series grouping (which is related to the media content item listed in the EEPG listing (400A, 400B, 400E) for recording. No queries, searches, or menus need be accessed by a consumer in order to develop the series groupings of the expanded series recording options (440A, 440B, 440E) that are presented. For example, a user-selection of button 444 (FIG. 4) will cause all NFC East Games to be scheduled for recording.

In one embodiment, an item of expanded media content information is presented as an item of decision support information to assist a user in a selection decision regarding the media content item. EEPG listing 400A shows an example of a plurality of items of expanded media content information presented as decision support information 430A. For example, injured reserve list information (431, 432) and weather information (433, 434) are presented to help a user decide whether not to watch or record the media content item (football game) displayed by EEPG listing 400A. For example, injured reserve list information 431 indicates that fullback Tiki Barber is out with a broken leg. If the consumer is a Tiki Barber fan, this information will likely assist in a decision as to whether or not to watch or record the media content item represented by EEPG listing 400A. Similarly, in one embodiment a selectable region/“button” such as button 435 may be provided to allow a user to easily search on demand options. For example, a user selection of button 435 will cause on-demand associated on-demand viewing options to be searches. In the presently describe example, this may allow a user to easily search for and find an on demand offering of classic football games between the New York Giants and the Jacksonville Jaguars.

FIGS. 5, 6, 7, and 8 provide additional examples of expanded media content information displayed in the form of EEPG listings 400B, 400C, 400D, and 400E.

FIG. 5 shows an example of expanding media content item information for a movie media item, in accordance with an embodiment of the present technology. FIG. 5 also shows examples of typical displayed metadata 420B and undisplayed metadata 410B from a listing from a typical EPG listing for a movie media content item. Thus, a typical EPG listing for a movie media content item would display metadata regarding the media content item such as a title 421B (Far and Away); a channel 422B (CH99); a network 423B (Lifetime) which is airing the media content item; a time slot 424B (7:00-9:00 p) in which the media content item is scheduled to air; and a brief description 425B of the media content item. Typically, undisplayed metadata such as a series identifier 411B is also included with an EPG listing.

In accordance with the system 200 and the method of flow diagram 300, metadata 410B and 420B are analyzed for trigger information (as previously described herein), and as previously described herein this trigger information is coupled to an individualized media content information gathering engine 220. In this case, the trigger information is provided to movie media content information gathering engine 220D, which then accesses one or more data sources, in the manner previously described to gather expanded media content item information based upon the trigger information. Some examples of trigger information, in this instance, may be “Tom Cruise”, “Nicole Kidman”, “Ron Howard”, “Oklahoma land rush”, and “Far and Away”. Thus expanded media content information such as a review, an age rating, awards received may be gathered, for example, from a movie database, a ratings service, and/or a program review service. Similarly, series groupings may be gathered in the manner previously described. Examples of such as series groupings include: movies staring Tom Cruise and Nicole Kidman; movies directed by Ron Howard; movies staring Ron Howard; movies staring Tom Cruise; movies starring Nicole Kidman; and programs about the Oklahoma land rush.

Still referring to FIG. 5, in one embodiment one or more items of gathered expanded information is presented in a displayable user interface along with the original EPG listing. In one embodiment, the expanded media content information is displayed as an enhanced electronic program guide (EEPG) listing 400B. In EEPG 400B original undisplayed metadata 410B is included (and may be displayed or hidden) and original displayed metadata 420B is included. Additionally, gathered information items are presented in the category of decision support information as a review 531, an age rating 532, awards received 533, to assist a user in a selection decision regarding the media content item (the movie Far and Away) represented by EEPG listing 400B. Similarly, the previously discussed series grouping are presented as expanded series recording options 541, 542, 543, 544, 545, and 546 under the category of expanded series recording options 440B, wherein the media content item (the movie Far and Away) is a member of each expanded series recording option.

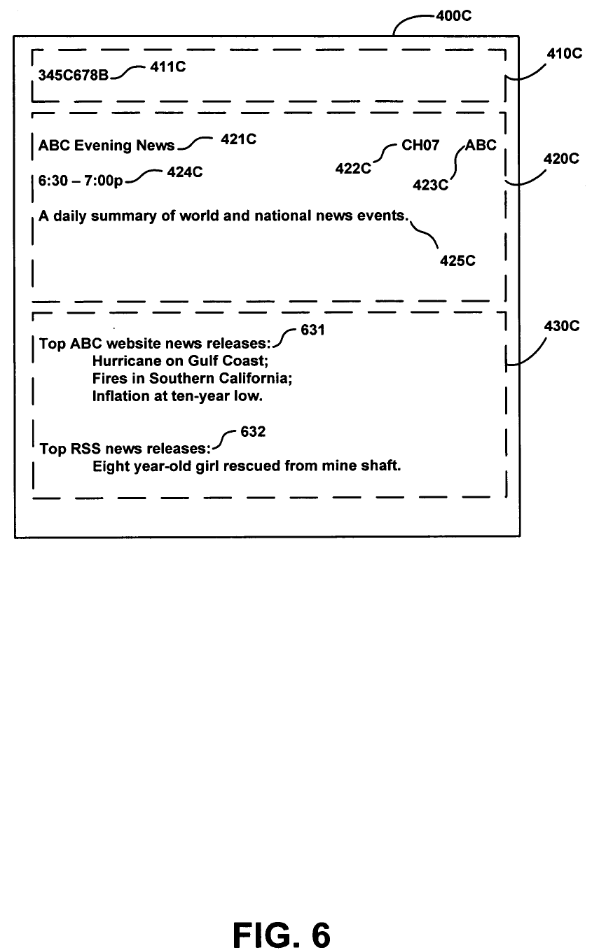

FIG. 6 shows an example of expanding media content item information for a news media item, in accordance with an embodiment of the present technology. FIG. 6 also shows examples of typical displayed metadata 420C and undisplayed metadata 410C from a listing from a typical EPG listing for a news media content item. Thus, a typical EPG listing for a news media content item would display metadata regarding the media content item such as a title 421C (ABC Evening News); a channel 422C (CH07); a network 423C (ABC) which is airing the media content item; a time slot 424C (6:30-7:00 p) in which the media content item is scheduled to air; and a brief description 425C of the media content item. Typically, undisplayed metadata such as a series identifier 411C is also included with an EPG listing.

In accordance with the system 200 and the method of flow diagram 300, metadata 410C and 420C are analyzed for trigger information (as previously described herein), and as previously described herein this trigger information is coupled to an individualized media content information gathering engine 220. In this case, the trigger information is provided to news media content information gathering engine 220B, which then accesses one or more data sources in the manner previously described to gather expanded media content item information based upon the trigger information. Some examples of trigger information, in this instance, may be “news”, “ABC Evening News”, and “summary of world and national news events”. Thus expanded media content information such as top ABC website news releases and top RSS news releases may be gathered, for example, from a news service, a network website, and/or a syndicated news feed such as an RSS subscription.

Still referring to FIG. 6, in one embodiment one or more items of gathered expanded information is presented in a displayable user interface along with the original EPG listing. In one embodiment, the expanded media content information is displayed as an enhanced electronic program guide (EEPG) listing 400C. In EEPG 400C original undisplayed metadata 410C is included (and may be displayed or hidden) and original displayed metadata 420C is included. Additionally, gathered information items discussed above are presented under the category of decision support information 430C, as top ABC website news releases 631 and top RSS news releases 632, to assist a user in a selection decision regarding the media content item (ABC Evening News) represented by EEPG listing 400C.

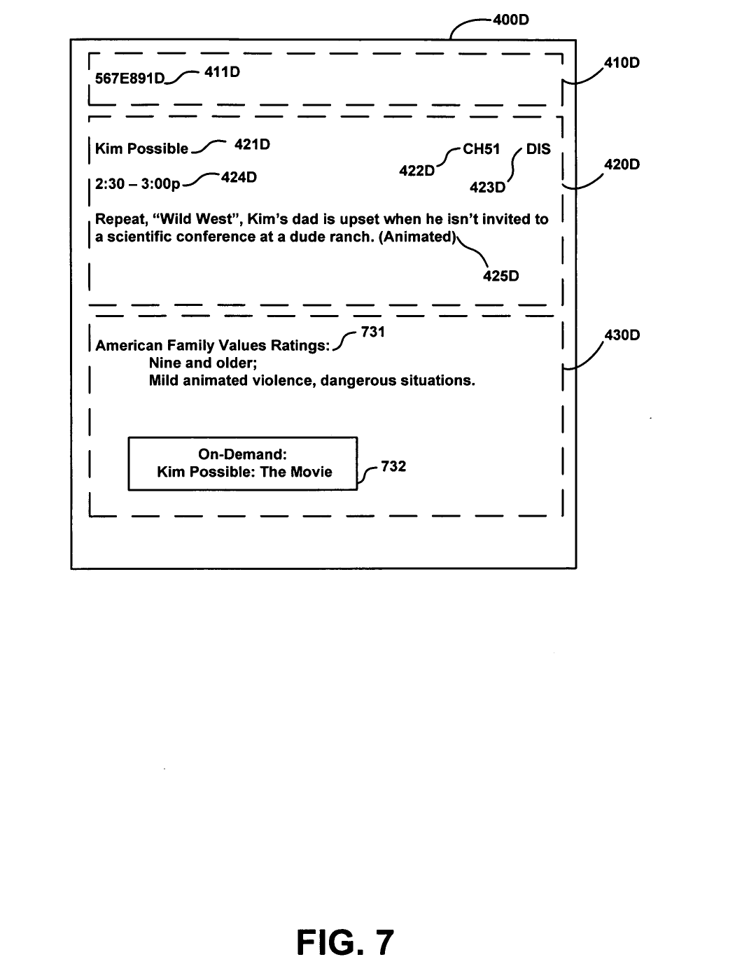

FIG. 7 shows an example of expanding media content item information for a children's show media item, in accordance with an embodiment of the present technology. FIG. 7 also shows examples of typical displayed metadata 420D and undisplayed metadata 410D from a listing from a typical EPG listing for a children's show media content item. Thus, a typical EPG listing for a children's show media content item would display metadata regarding the media content item such as a title 421D (Kim Possible); a channel 422D (CH51); a network 423D (Disney) which is airing the media content item; a time slot 424D (2:30-3:00 p) in which the media content item is scheduled to air; and a brief description 425D of the media content item. Typically, undisplayed metadata such as a series identifier 411D is also included with an EPG listing.

In accordance with the system 200 and the method of flow diagram 300, metadata 410D and 420D are analyzed for trigger information (as previously described herein), and as previously described herein this trigger information is coupled to an individualized media content information gathering engine 220. In this case, the trigger information is provided to children's show media content information gathering engine 220C, which then accesses one or more data sources in the manner previously described to gather expanded media content item information based upon the trigger information. Some examples of trigger information, in this instance, may be “DIS”, “Kim Possible”, and “Animated”. Thus expanded media content information such as an American Family Values Rating, for example, may be gathered from a data source such as a ratings service, and/or a program review service.

Still referring to FIG. 7, in one embodiment one or more items of gathered expanded information is presented in a displayable user interface along with the original EPG listing. In one embodiment, the expanded media content information is displayed as an enhanced electronic program guide (EEPG) listing 400D. In EEPG 400D original undisplayed metadata 410D is included (and may be displayed or hidden) and original displayed metadata 420D is included. Additionally, the gathered information item, described above, is presented under the category of decision support information 430D as an American Family Values Rating 731, to assist a user in a selection decision regarding the media content item (the children's show Kim Possible) represented by EEPG listing 400D. For example, a parent might use this additional information to decide whether to allow a child to watch this media content item. Moreover, as shown by selectable region/“button” 732, decision support information may include a listing of one or more selectable or non-selectable on-demand viewing options associated with the media content item. For example, a user selection of button 732, via cursor control 116, alphanumeric inpu 116, or command input 116 causes “Kim Possible: The Movie” to be played from an on-demand service.

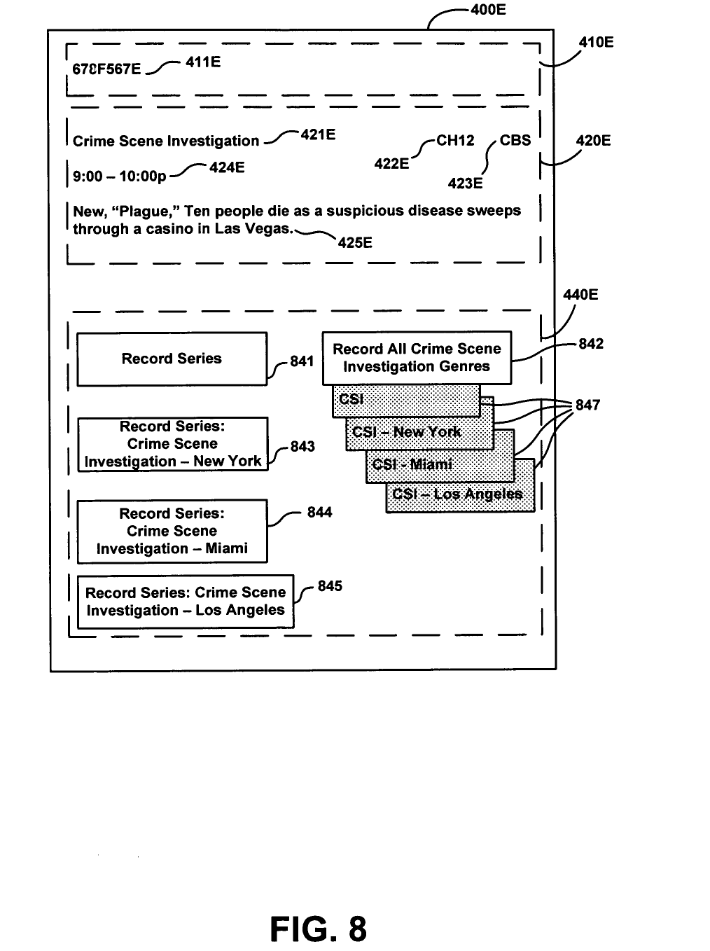

FIG. 8 shows an example of expanding media content item information for a prime time television media item, in accordance with an embodiment of the present technology. FIG. 8 also shows examples of typical displayed metadata 420E and undisplayed metadata 410E from a listing from a typical EPG listing for a prime time television show media content item. Thus, a typical EPG listing for a prime time television show media content item would display metadata regarding the media content item such as a title 421E (Crime Scene Investigation); a channel 422E (CH12); a network 423E (CBS) which is airing the media content item; a time slot 424E (9:00-10:00 p) in which the media content item is scheduled to air; and a brief description 425E of the media content item. Typically, undisplayed metadata such as a series identifier 411E is also included with an EPG listing.

In accordance with the system 200 and the method of flow diagram 300, metadata 410E and 420E are analyzed for trigger information (as previously described herein), and as previously described herein this trigger information is coupled to an individualized media content information gathering engine 220. In this case, the trigger information is provided to prime time television show media content information gathering engine 220N, which then accesses one or more data sources in the manner previously described to gather expanded media content item information based upon the trigger information. Some examples of trigger information, in this instance, may be “Crime Scene Investigation” and “Las Vegas”. Thus, series groupings may be gathered in the manner previously described. Examples of such series groupings include: a series grouping of the episodes of the present media content item; an über-series grouping of all spin-offs from the prime time television show Crime Scene Investigation (for example: Crime Scene Investigation, Crime Scene Investigation—New York, Crime Scene Investigation—Miami, and Crime Scene Investigation—Los Angeles); a first grouping of episodes of a single spin-off prime time television show (Crime Scene Investigation—New York); a second grouping of episodes of a single spin-off prime time television show (Crime Scene Investigation—Miami); and a third grouping of episodes of a single spin-off prime time television show (Crime Scene Investigation—Los Angeles).

Still referring to FIG. 8, in one embodiment one or more items of gathered expanded information is presented in a displayable user interface along with the original EPG listing. In one embodiment, the expanded media content information is displayed as an enhanced electronic program guide (EEPG) listing 400E. In EEPG 400E original undisplayed metadata 410E is included (and may be displayed or hidden) and original displayed metadata 420E is included. Additionally, series groupings, described above, are presented under the category of expanded series recording options 440E, as individual expanded series recording options 841, 842, 843, 844, and 845. The media content item of EEPG listing 440E is a member of, or is related to, each expanded series recording option (841, 842, 843, 844, and 845). In one embodiment, as previously described, each expanded series recording option (841, 842, 843, 844, and 845) comprises a selectable region or “button” which a user may select for execution via command input 115, cursor control 116, alphanumeric input 114 or some other selection means.

### Displaying an Expanded Series Recording Option for a Listing of a Media Content Item in an Electronic Program Guide

FIG. 9 is a flow diagram 900 of operations performed in accordance with one embodiment of the present technology for expanding media content item information. More specifically, FIG. 9 illustrates a flow diagram 900 of an example embodiment of a method in a computer system for displaying on a display device an expanded series recording option for a listing of a media content item in an electronic program guide. Elements of system 200 and flow diagram 900 are explained below, with reference to elements of FIG. 4 and FIG. 8, and steps of flow diagram 300 of FIG. 3.

At step 910 of flow diagram 900, in one embodiment, the method performs a specialized data collection process to generate a series grouping of which the media content item is a member. In such an embodiment, the specialized data collection process is based upon metadata of the listing. This is consistent with the previous description of utilizing an individualized media content information gathering engine 220 as described in conjunction with step 330 of flow diagram 300, except that this is a more focused implementation. In the interests of brevity and clarity, similar elements of this method will not be re-described herein.

In one embodiment, step 910 comprises utilizing collaborative filtering data from a plurality of users to determine a series grouping of which a media content item is a member. With reference to FIG. 2 and to FIG. 8, in one embodiment, prime time television show media content information gathering engine 220N accesses a collaborative filter to determine a list of other prime time television shows that are recorded by consumers who watch or record the show “Crime Scene Investigation” 421E or series identification 411E.

Information gathered from such a collaborative filter may indicate that such consumers additionally watch or record the spin-off shows of Crime Scene Investigation—New York, Crime Scene Investigation—Miami, and Crime Scene Investigation—Los Angeles. In response to gathering this expanded media content item information, prime time television show media content information gathering engine 220N may then create an über-series grouping of which the media content item (Crime Scene Investigation) is a member.

With continued reference to step 910 and to FIG. 2 and FIG. 4, in one embodiment, prime time television show media content information gathering engine 220A accesses a collaborative filter to determine a list of other prime time television shows that are recorded by consumers who watch or record the sporting event “MONDAY NIGHT FOOTBALL” 421A, or series identifier 411A.

Information gathered from such a collaborative filter may indicate that such consumers additionally watch or record New York Giants games and NFC East games. Thus, in one embodiment, in response to gathering this expanded media content item information, prime time television show media content information gathering engine 220A may then create a series grouping of New York Giants games and an series grouping of AFC East games both of which the media content item (the football game of the New York Giants at Jacksonville Jaguars) is a member.

In one embodiment, step 910 of the method comprises comparing series identifier metadata of the listing to a set of series identifier metadata rules to determine a grouping of related listings of differing series identifier metadata. In one such embodiment, the media content item is a member of the grouping of related listings. With reference to FIG. 2 and to FIG. 8, in one embodiment, prime time television show media content information gathering engine 220N accesses or utilizes a set of series identifier metadata filtering rules to determine a list of other prime time television shows that are related to the series identifier 411E. In one embodiment, this involves comparing series identifier 411E metadata of the listing to a set of series identifier metadata rules to determine if the media content item of the listing is a member of an über-series.

Information gathered from such an effort may indicate that spin-off shows of Crime Scene Investigation—New York, Crime Scene Investigation—Miami, and Crime Scene Investigation—Los Angeles are related to “Crime Scene Investigation”, even though they do not share series identifier 411E in common. In response to gathering this expanded media content item information, prime time television show media content information gathering engine 220N may then create an über-series grouping of which the media content item (Crime Scene Investigation) is a member or create individual related series groupings for each of the related media items/shows.

At step 920 of flow diagram 900, in one embodiment, the method presents the series grouping upon the display device as an expanded series recording option in an enhanced electronic programming guide listing associated with the media content item. This is consistent with the previous description of presenting a series grouping as part of an enhanced electronic programming guide listing (EEPG listing), which was described in conjunction with the method of flow diagram 300 in FIG. 3. With reference to FIG. 9, in one embodiment, an über-series grouping is presented as an expanded recording option 842 in an EEPG listing 440E which is displayed on a television or other display device 118.

In one embodiment, presenting a series grouping as an enhanced recording option 440E also comprises presenting a description of the series grouping. This is useful so that a consumer may decide quickly whether or not they are interested in recording items of the series grouping. For example, in one embodiment, when presented as an EEPG listing, the über-series grouping which becomes expanded recording option 842 has a descriptive title of “Record All Crime Scene Investigation Genres”.

In some instances it is useful to present even more information to a consumer. In these instances, presenting the series grouping upon the display device as an expanded series recording option in an enhanced electronic programming guide listing associated with the media content item further comprises presenting a listing of media content items in the series grouping. A listing 847 of the media content items constituted by expanded series recording option 842, is shown in EEPG listing 440E. Each media content item in the über-series grouping represented by expanded recording option 842 is listed by title in listing 847. This provides additional information to a consumer, which assists the consumer in making a decision on whether or not to select and record a presented expanded series recording option such as expanded series recording option 842.

At step 930 of flow diagram 900, in one embodiment, in response to a user selection of an expanded series recording option, the method marks items of the respective series grouping for recording. For example, in an embodiment in which method 900 is implemented in a digital video recorder, recording functionality of the digital video recorder is accessed and utilized to “mark for recording” the media content items which belong to a series grouping which has been selected for recording by selecting an expanded series recording option. Such a user selection may be made, in one embodiment, by using a remote control or other cursor control device 116 to manipulate a cursor or other selection device to select an expanded series recording option provided in an EEPG listing.

Example embodiments of the present technology for expanding media content item information are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for expanding upon media content information presented in a listing of a media content item in an electronic program guide, said method comprising:
analyzing metadata of a listing of a media content item in an electronic program guide to identify trigger information associated with said media content item;
providing said trigger information to an individualized media content information gathering engine; and
utilizing said individualized media content information gathering engine to perform a specialized data collection process based upon said trigger information, said specialized data collection process for gathering expanded media content information regarding said media content item.

2. The method as recited in claim 1, further comprising:
presenting an item of gathered expanded media content information in a displayable user interface along with said listing.

3. The method as recited in claim 2, wherein said presenting an item of gathered expanded media content information in a displayable user interface along with said listing comprises:
presenting an expanded series recording option, wherein said media content item is a member of a grouping of media items encompassed by said expanded series recording option.

4. The method as recited in claim 2, wherein said presenting an item of gathered expanded media content information in a displayable user interface along with said listing comprises:
presenting an item of decision support information to assist a user in a selection decision regarding said media content item.

5. The method as recited in claim 1, wherein said analyzing metadata of listing a media content item in an electronic program guide to identify trigger information associated with said media content item comprises:
analyzing an item of metadata selected from the group of metadata items consisting of:
a title of said media content item, a description of said media content item provided in said listing, a series identifier of said listing, a genre of said listing, and a duration of said listing, a portion of the broadcast content of said media item.

6. The method as recited in claim 1, wherein said providing said trigger information to an individualized media content information gathering engine comprises:
providing said trigger information to an individualized media content information gathering engine selected from the group of individualized media content information gathering engines consisting of:
a sports media content information gathering engine, a news media content information gathering engine, a movie media content information gathering engine, a children's programming media content information gathering engine, and a prime time television show media content gathering engine.

7. The method as recited in claim 1, wherein said utilizing said individualized media content information gathering engine to perform a specialized data collection process based upon said trigger information comprises:
generating at least one series grouping of which said media content item is a member.

8. The method as recited in claim 1, wherein said utilizing said individualized media content information gathering engine to perform a specialized data collection process based upon said trigger information comprises:
utilizing said individualized media content information gathering engine to gather information from an information source selected from a group of information sources consisting of:
a second electronic program guide listing, a sports information service, a historical listing of sports broadcasts, a ratings service, a weather service, a movie database, a news service, a syndication feed, and a programming review service.

9. A method in a computer system for displaying on a display device an expanded series recording option for a listing of a media content item in an electronic program guide, said method comprising:
performing a specialized data collection process to generate a series grouping of which said media content item is a member, said specialized data collection process being based upon metadata of said listing;
presenting said series grouping upon said display device as an expanded series recording option in an enhanced electronic programming guide listing associated with said media content item; and
in response to a user selection of said expanded series recording option, marking items of said series grouping for recording.

10. The method as recited in claim 9, wherein said performing a specialized data collection process to generate a series grouping of which said media content item is a member comprises:
utilizing collaborative filtering data from a plurality of users to determine a series grouping of which media content item is a member.

11. The method as recited in claim 9, wherein said performing a specialized data collection process to generate a series grouping of which said media content item is a member comprises:
comparing series identifier metadata of said listing to a set of series identifier metadata rules to determine a grouping of related listings of differing series identifier metadata, said media content item being a member of said grouping of related listings.

12. The method as recited in claim 11, wherein said comparing series identifier metadata of said listing to a set of series identifier metadata rules to determine a grouping of related listings of differing series identifier metadata, said media content item being a member of said grouping of related listings comprises:
comparing series identifier metadata of said listing to said set of series identifier metadata rules to determine if said media content item is a member of an über-series.

13. The method as recited in claim 9, wherein said presenting said series grouping upon said display device as an expanded series recording option in an enhanced electronic programming guide listing associated with said media content item further comprises:
presenting a description of said series grouping.

14. The method as recited in claim 9, wherein said presenting said series grouping upon said display device as an expanded series recording option in an enhanced electronic programming guide listing associated with said media content item further comprises:
presenting a listing of media content items in said series grouping.

15. A media content information expanding system, said system comprising:
an electronic program guide metadata analyzer configured for identifying trigger information from metadata associated with listing of a media content item in an electronic program guide;
an individualized media content information gathering engine coupled to said electronic program guide metadata analyzer, said individualized media content information gathering engine configured for performing a specialized data collection process based upon said trigger information, said specialized data collection process for gathering expanded media content information regarding said media content item; and
a media content information presenter coupled to said individualized media content information gathering engine, said media content information presenter configured for presenting a gathered item of expanded media content information in a displayable user interface.

16. The system of claim 15, wherein said metadata comprises an series identifier of said listing.

17. The system of claim 15, wherein said metadata comprises a title of said media content item.

18. The system of claim 15, wherein said metadata comprises a portion of a description of said media content item.

19. The system of claim 15, wherein said individualized media content information gathering engine is selected from the group of individualized media content information gathering engines consisting of:
a sports media content information gathering engine, a news media content information gathering engine, a movie media content information gathering engine, and a children's programming media content information gathering engine.

20. The system of claim 15, wherein said gathered item of expanded media content information is presented as an expanded series recording option in an electronic program guide.
